(19) United States
(12) Patent Application Publication
(10) Pub. No.: US 2026/0255120 A1
(43) Pub. Date: Aug. 27, 2026

(54) Apparatus, Methods and Computer Programs for Enabling Rendering of Spatial Audio Signals

(71) Applicant: Nokia Technologies Oy, Espoo (FI)

(72) Inventors: Mikko-Ville LAITINEN, Espoo (FI); Jussi VIROLAINEN, Espoo (FI); Juha VILKAMO, Helsinki (FI)

(21) Appl. No.: 17/919,310

(22) PCT Filed: Apr. 9, 2021
(86) PCT No.: PCT/FI2021/050258

§ 371 Date: Oct. 17, 2022

(30) Foreign Application Priority Data
Apr. 20, 2020 (GB) 2005740.2

(51) Int. Cl. H04S 7/00

(52) U.S. Cl. CPC H04S 7/302; H04S 2400/11

(57) ABSTRACT

An apparatus for enabling spatial rendering of audio signals that have had an audio effect applied to them. The apparatus includes circuitry configured for: obtaining one or more audio signals; obtaining one or more spatial metadata relating to the one or more obtained audio signals wherein the one or more spatial metadata includes information that indicates how to spatially reproduce the one or more obtained audio signals; applying one or more audio effects to the one or more obtained audio signals to provide one or more altered audio signals; obtaining audio effect information where the audio effect information includes information relating to how application of the one or more audio effects affects one or more signal characteristics of the one or more obtained audio signals; and using the obtained audio effect information and the one or more spatial metadata to enable the indicated spatial rendering of the one or more altered audio signals.

### TECHNOLOGICAL FIELD

Embodiments of the present disclosure relate to apparatus, methods and computer programs for enabling rendering of spatial audio signals. Some relate to apparatus, methods and computer programs for enabling rendering of spatial audio signals that have audio effects applied to them.

### BACKGROUND

Some audio devices enable users to apply special effects to audio signals. For example, a user may be able to speed up or slow down an audio signal. Such changes in speed could be used to accompany video or other images. In some examples a user could apply special effects such as pitch shifting or other effects that could enable voice disguising. When such effects are applied they can adversely affect any spatialization of the audio signal.

### BRIEF SUMMARY

According to various, but not necessarily all, examples of the disclosure there is provided an apparatus comprising means for: obtaining one or more audio signals; obtaining one or more spatial metadata relating to the one or more obtained audio signals wherein the one or more spatial metadata comprises information that indicates how to spatially reproduce the one or more obtained audio signals; applying one or more audio effects to the one or more obtained audio signals to provide one or more altered audio signals; obtaining audio effect information where the audio effect information comprises information relating to how application of the one or more audio effects affects one or more signal characteristics of the one or more obtained audio signals; and using the obtained audio effect information and the one or more spatial metadata to enable the indicated spatial rendering of the one or more altered audio signals.

The audio effect may comprise an effect that alters at least one of; spectral characteristics of the one or more obtained audio signals, temporal characteristics of the one or more obtained audio signals.

The audio effect information may comprise information relating to how application of the one or more audio effects affects one or more signal characteristics of the one or more obtained audio signals as a function of, at least one of, frequency or time.

The audio effect information may be obtained, at least in part, from processing using an audio effect control signal wherein the audio effect control signal controls the audio effect applied to the one or more obtained audio signals.

Using the obtained audio effect information and the one or more spatial metadata to enable the indicated spatial rendering of the one or more altered audio signals may comprise generating modified spatial metadata based on the audio effect information and using the modified one or more spatial metadata to render the altered audio signals.

Using the obtained audio effect information and the one or more spatial metadata to enable the indicated spatial rendering of the one or more altered audio signals may comprise adjusting one or more frequency bands used for rendering the one or more altered audio signals.

Using the obtained audio effect information and the one or more spatial metadata to enable the indicated spatial rendering of the one or more altered audio signals may comprise adjusting the sizes of one or more time frames used for rendering the altered audio signals.

The one or more altered audio signals may comprise an effect-processed audio signal.

The apparatus may comprise means for, at least partially, compensating for spatial characteristics from the one or more obtained audio signals before applying one or more audio effects.

The spatial characteristics that are, at least partially, compensated for may comprise binaural characteristics.

The apparatus may comprise means for analysing covariance matrix characteristics of the one or more altered audio signals and adjusting the spatial rendering so that the covariance matrix of the rendered audio signals match a target covariance matrix.

The spatial metadata and the audio effect information may be used to, at least partially, retain the spatial characteristics of the one or more obtained audio signals when the one or more altered audio signals are rendered.

The one or more spatial metadata may comprise, for one or more frequency sub-bands; a sound direction parameter, and an energy ratio parameter.

The one or more obtained audio signals may be captured by the apparatus.

The one or more obtained audio signals may be captured by a separate capturing device and transmitted to the apparatus.

At least one of the one or more spatial metadata, and an audio effect control signal may be transmitted to the apparatus from the capturing device.

According to various, but not necessarily all, examples of the disclosure there is provided, an apparatus comprising: at least one processor; and at least one memory including computer program code; the at least one memory and the computer program code configured to, with the at least one processor, cause the apparatus at least to perform; obtaining one or more audio signals; obtaining one or more spatial metadata relating to the one or more obtained audio signals wherein the one or more spatial metadata comprises information that indicates how to spatially reproduce the one or more obtained audio signals; applying one or more audio effects to the one or more obtained audio signals to provide one or more altered audio signals; obtaining audio effect information where the audio effect information comprises information relating to how application of the one or more audio effects affects one or more signal characteristics of the one or more obtained audio signals; and using the obtained audio effect information and the one or more spatial metadata to enable the indicated spatial rendering of the one or more altered audio signals.

According to various, but not necessarily all, examples of the disclosure there is provided a method comprising: obtaining one or more audio signals; obtaining one or more spatial metadata relating to the one or more obtained audio signals wherein the one or more spatial metadata comprises information that indicates how to spatially reproduce the one or more obtained audio signals; applying one or more audio effects to the one or more obtained audio signals to provide one or more altered audio signals;

obtaining audio effect information where the audio effect information comprises information relating to how application of the one or more audio effects affects one or more signal characteristics of the one or more obtained audio signals; and using the obtained audio effect information and the one or more spatial metadata to enable the indicated spatial rendering of the one or more altered audio signals.

In some methods the audio effect may comprise an effect that alters at least one of; spectral characteristics of the one or more obtained audio signals, temporal characteristics of the one or more obtained audio signals.

In some methods the audio effect information may comprise information relating to how application of the one or more audio effects affects one or more signal characteristics of the one or more obtained audio signals as a function of, at least one of, frequency or time.

In some methods the audio effect information may be obtained, at least in part, from processing using an audio effect control signal wherein the audio effect control signal controls the audio effect applied to the one or more obtained audio signals.

In some methods using the obtained audio effect information and the one or more spatial metadata to enable the indicated spatial rendering of the one or more altered audio signals may comprise generating modified spatial metadata based on the audio effect information and using the modified one or more spatial metadata to render the altered audio signals.

In some methods using the obtained audio effect information and the one or more spatial metadata to enable the indicated spatial rendering of the one or more altered audio signals may comprise adjusting one or more frequency bands used for rendering the one or more altered audio signals.

In some methods using the obtained audio effect information and the one or more spatial metadata to enable the indicated spatial rendering of the one or more altered audio signals may comprise adjusting the sizes of one or more time frames used for rendering the altered audio signals.

In some methods the one or more altered audio signals may comprise an effect-processed audio signal.

In some methods the method may comprise, at least partially, compensating for spatial characteristics from the one or more obtained audio signals before applying one or more audio effects.

In some methods the spatial characteristics that are, at least partially, compensated for may comprise binaural characteristics.

In some methods the method may comprise means for analysing covariance matrix characteristics of the one or more altered audio signals and adjusting the spatial rendering so that the covariance matrix of the rendered audio signals match a target covariance matrix.

In some methods the spatial metadata and the audio effect information may be used to, at least partially, retain the spatial characteristics of the one or more obtained audio signals when the one or more altered audio signals are rendered.

In some methods the one or more spatial metadata may comprise, for one or more frequency sub-bands; a sound direction parameter, and an energy ratio parameter.

In some methods the one or more obtained audio signals may be captured by the apparatus.

In some methods the one or more obtained audio signals may be captured by a separate capturing device and transmitted to the apparatus.

In some methods at least one of the one or more spatial metadata, and an audio effect control signal may be transmitted to the apparatus from the capturing device.

According to various, but not necessarily all, examples of the disclosure there is provided, a computer program comprising computer program instructions that, when executed by processing circuitry, cause: obtaining one or more audio signals; obtaining one or more spatial metadata relating to the one or more obtained audio signals wherein the one or more spatial metadata comprises information that indicates how to spatially reproduce the one or more obtained audio signals; applying one or more audio effects to the one or more obtained audio signals to provide one or more altered audio signals; obtaining audio effect information where the audio effect information comprises information relating to how application of the one or more audio effects affects one or more signal characteristics of the one or more obtained audio signals; and using the obtained audio effect information and the one or more spatial metadata to enable the indicated spatial rendering of the one or more altered audio signals.

In some computer programs the audio effect comprises an effect that alters at least one of; spectral characteristics of the one or more obtained audio signals, temporal characteristics of the one or more obtained audio signals.

### BRIEF DESCRIPTION

Some examples will now be described with reference to the accompanying drawings in which:

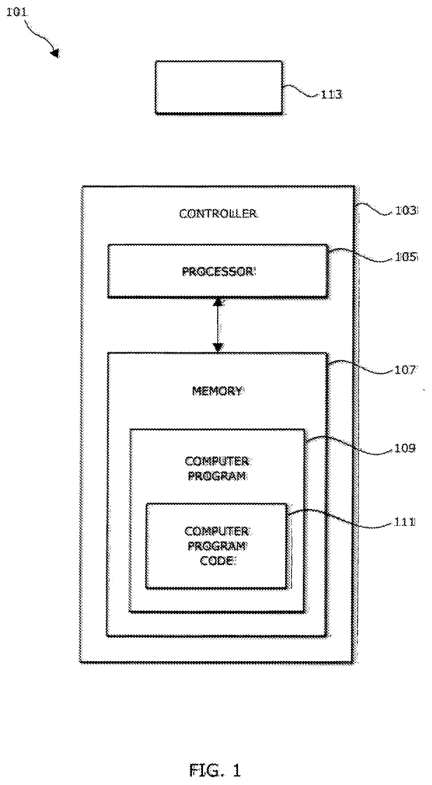

FIG. 1 illustrates an example apparatus;

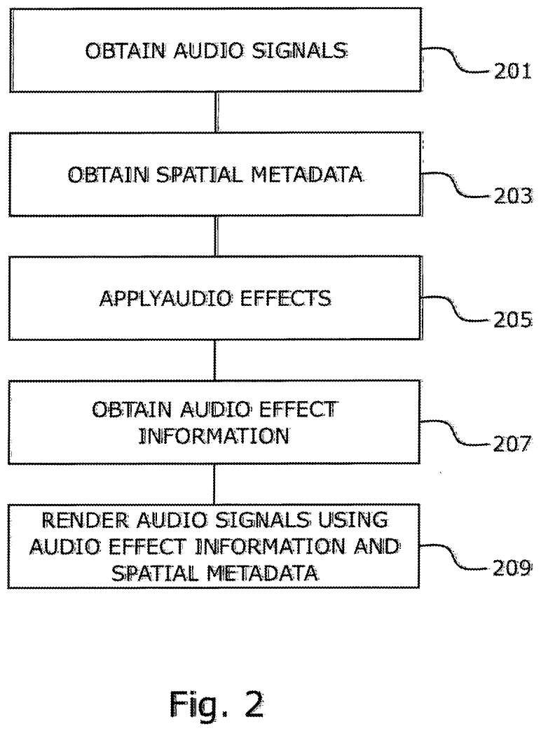

FIG. 2 illustrates an example method;

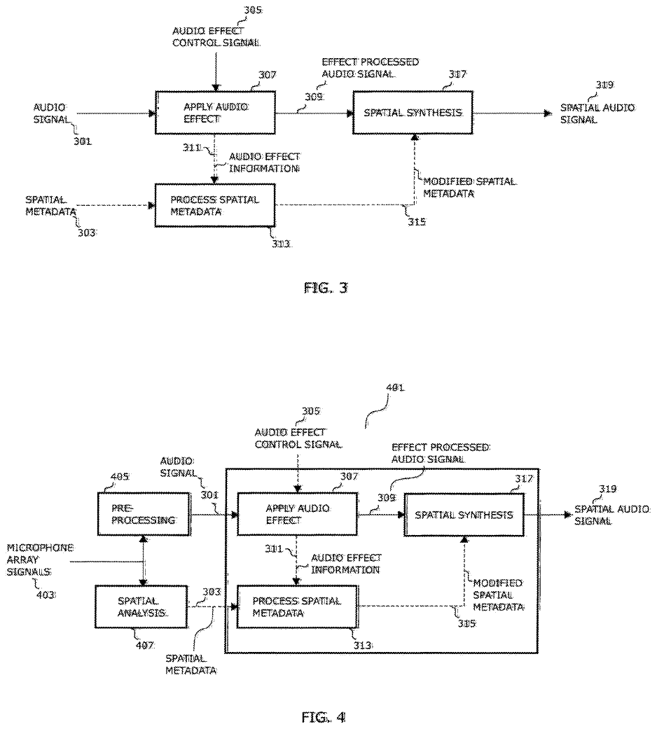

FIG. 3 illustrates an example apparatus;

FIG. 4 illustrates an example apparatus;

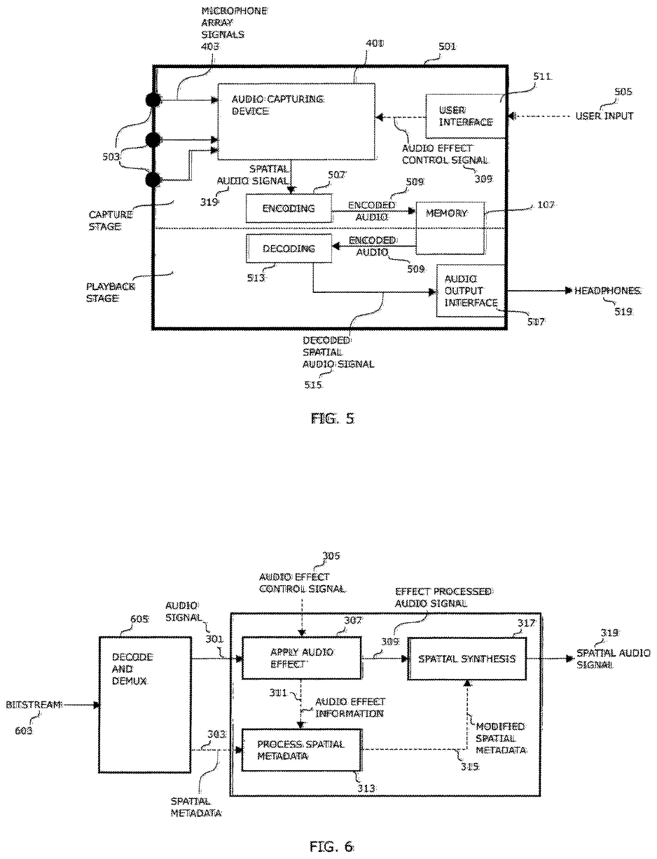

FIG. 5 illustrates an example system;

FIG. 6 illustrates an example apparatus;

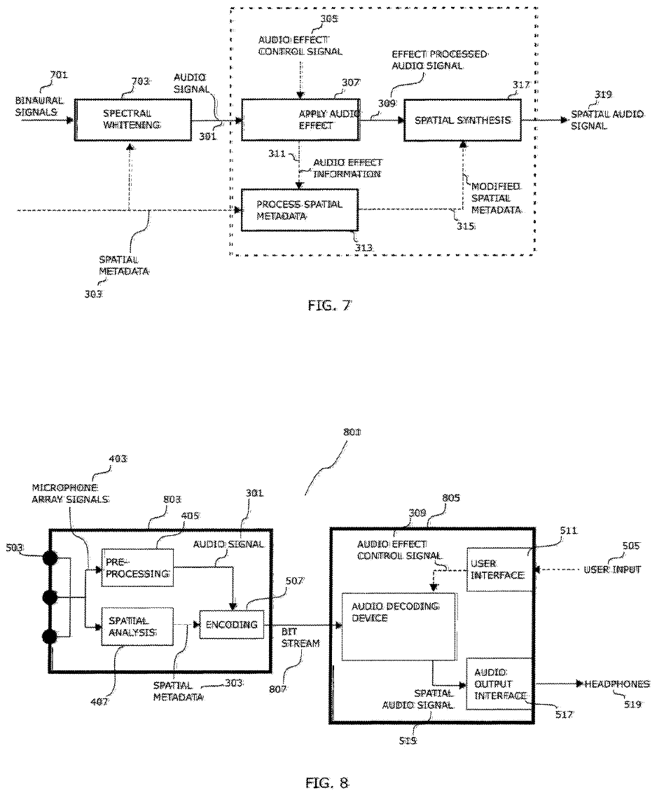

FIG. 7 illustrates an example apparatus; and

FIG. 8 illustrates an example system;

### DETAILED DESCRIPTION

The FIGS. illustrates an apparatus 101 which can be configured to enable rendering of spatial audio signals. The apparatus 101 comprises means for: obtaining 201 one or more audio signals 301; obtaining 203 one or more spatial metadata 303 relating to the one or more obtained audio signals 301 wherein the one or more spatial metadata 303 comprises information that indicates how to spatially reproduce the audio signals 301; applying 205 one or more audio effects to the one or more obtained audio signals 301 to provide one or more altered audio signals 309; obtaining 207 audio effect information 311 where the audio effect information comprises information relating to how application of the one or more audio effects affects one or more signal characteristics of the one or more obtained audio signals 301; and using 209 the obtained audio effect information 311 and the one or more spatial metadata 303 to enable the indicated spatial rendering of the one or more altered audio signals 309.

The apparatus 101 according to examples of the disclosure therefore enables rendering of spatial audio after audio effects have been applied to the spatial audio.

FIG. 1 schematically illustrates an apparatus 101 according to examples of the disclosure. The apparatus 101 illustrated in FIG. 1 may be a chip or a chip-set. In some examples the apparatus 101 may be provided within devices such as a processing device. In some examples the apparatus 101 may be provided within an audio capture device or an audio rendering device.

In the example of FIG. 1 the apparatus 101 comprises a controller 103. In the example of FIG. 1 the implementation of the controller 103 may be as controller circuitry. In some examples the controller 103 may be implemented in hardware alone, have certain aspects in software including firmware alone or can be a combination of hardware and software (including firmware).

As illustrated in FIG. 1 the controller 103 may be implemented using instructions that enable hardware functionality, for example, by using executable instructions of a computer program 109 in a general-purpose or special-purpose processor 105 that may be stored on a computer readable storage medium (disk, memory etc) to be executed by such a processor 105.

The processor 105 is configured to read from and write to the memory 107. The processor 105 may also comprise an output interface via which data and/or commands are output by the processor 105 and an input interface via which data and/or commands are input to the processor 105.

The memory 107 is configured to store a computer program 109 comprising computer program instructions (computer program code 111) that controls the operation of the apparatus 101 when loaded into the processor 105. The computer program instructions, of the computer program 109, provide the logic and routines that enables the apparatus 101 to perform the methods illustrated in FIG. 2. The processor 105 by reading the memory 107 is able to load and execute the computer program 109.

The apparatus 101 therefore comprises: at least one processor 105; and at least one memory 107 including computer program code 111, the at least one memory 107 and the computer program code 111 configured to, with the at least one processor 105, cause the apparatus 101 at least to perform; obtaining 201 one or more audio signals 301; obtaining 203 one or more spatial metadata 303 relating to the audio signals 301 wherein the one or more spatial metadata 303 comprises information that indicates how to spatially reproduce the one or more obtained audio signals 301; applying 205 one or more audio effects to the one or more obtained audio signals 301 to provide one or more altered audio signals 309; obtaining 207 audio effect information 311 where the audio effect information comprises information relating to how application of the one or more audio effects affects one or more signal characteristics of the one or more obtained audio signals 301; and using 209 the obtained audio effect information 311 and the one or more spatial metadata 303 to enable the indicated spatial rendering of the one or more altered audio signals 309.

As illustrated in FIG. 1 the computer program 109 may arrive at the apparatus 101 via any suitable delivery mechanism 113. The delivery mechanism 113 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 109. The delivery mechanism may be a signal configured to reliably transfer the computer program 109. The apparatus 101 may propagate or transmit the computer program 109 as a computer data signal. In some examples the computer program 109 may be transmitted to the apparatus 101 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 109 comprises computer program instructions for causing an apparatus 101 to perform at least the following: obtaining 201 one or more audio signals 301; obtaining 203 one or more spatial metadata 303 relating to the audio signals 301 wherein the spatial metadata 303 comprises information that indicates how to spatially reproduce the one or more obtained audio signals 301; applying 205 one or more audio effects to the one or more obtained audio signals 301 to provide altered audio signals 309; obtaining 207 audio effect information 311 where the audio effect information comprises information relating to how application of the one or more audio effects affects one or more signal characteristics of the one or more obtained audio signals 301; and using 209 the obtained audio effect information 311 and the one or more spatial metadata 303 to enable the indicated spatial rendering of the one or more altered audio signals 309.

The computer program instructions may be comprised in a computer program 109, a non-transitory computer readable medium, a computer program product, a machine readable medium. In some but not necessarily all examples, the computer program instructions may be distributed over more than one computer program 109.

Although the memory 107 is illustrated as a single component/circuitry it may be implemented as one or more separate components/circuitry some or all of which may be integrated/removable and/or may provide permanent/semi-permanent/dynamic/cached storage.

Although the processor 105 is illustrated as a single component/circuitry it may be implemented as one or more separate components/circuitry some or all of which may be integrated/removable. The processor 105 may be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

FIG. 2 illustrates an example method. The method could be implemented using apparatus 101 as shown in FIG. 1.

At block 201 the method comprises obtaining one or more audio signals 301. In some examples the audio signals 301 can comprise signals that have been captured by a plurality of microphones of the apparatus 101 or microphones that are coupled to the apparatus 101. In some examples the audio signals 301 can be captured by a recording device that is separate to the apparatus 101. In such examples the audio signals 301 can be transmitted to the apparatus 101 via any suitable communication link. The audio signals 301 can be stored in a memory 107 of the apparatus 101 and can be retrieved from the memory 107 when needed.

The audio signals 301 can comprise one or more channels. The one or more channels, in addition with any spatial metadata as needed, can enable spatial audio to be rendered by a rendering device. The spatial audio is audio rendered so that a user can perceive spatial properties of the audio signal. For example, the spatial audio may be rendered so that a user can perceive the direction of origin and the distance from an audio source. In some examples spatial audio may enable an immersive audio experience to be provided to the user. The immersive audio experience could comprise a virtual reality or augmented reality experience or any other suitable experience.

The method also comprises, at block 203, obtaining spatial metadata 303 relating to the audio signals wherein the spatial metadata 303 comprises information that indicates how to spatially reproduce the audio signals 301. The spatial metadata 303 may comprise information such as the direction of arrival of audio, distances to an audio source, direct-to-total energy ratios, diffuse-to-total energy ratio or any other suitable information. The spatial metadata 303 may be provided in frequency bands. In some examples the spatial metadata 303 may comprise, for one or more frequency sub-bands; a sound direction parameter, and an energy ratio parameter.

In the example shown in FIG. 2 the spatial metadata 303 can be obtained with the audio signals 301. For instance, the apparatus 101 can receive a signal via a communication link where the signal comprises both the audio signals 301 and the spatial metadata 303. In other examples the spatial metadata 303 can be obtained separately to the audio signals 301. For instance, the apparatus 101 can obtain the audio signals 301 and then can separately process the audio signals 301 to obtain the spatial metadata 303.

At block 205 the method comprises applying one or more audio effects to the obtained audio signals 301 to provide one or more altered audio signals 309. The audio effect comprises an audio effect that alters at least one of the spectral characteristics of the obtained audio signals 301 or the temporal characteristics of the obtained audio signals 301.

In some examples the audio effects can comprise effects which change the playback rate of the obtained audio signals 301. In some examples the playback rate can be changed to match the playback rate of accompanying video or other images. For instance, the audio signals 301 could be played at an increased rate to match video that has been sped up or at a slower rate to match video that has slowed down.

Different changes in playback rates can be provided by the audio effects. The change in playback rate can range from a slight change (for example one and a half times), to a moderate change (for example, four times) to a large change (for example twenty times).

The changes in the playback rates can be achieved using interpolation of the audio waveforms within the audio signals 301, time scale modification of the audio signals 301 or any other suitable process or combination of processes.

In some examples the one or more audio effects could comprise pitch shift effects. The pitch shift effects can be used to purposely change the pitch of the audio signal 301. This could be used to create the effect of a person speaking in a higher tone or in a lower tone or any other suitable effect.

Any suitable process can be used to achieve the pitch shift. In some examples the pitch shift can be achieved by combining time-scale modification processing and sampling rate conversion. For instance, to achieve a pitch that is twice as high the audio signal is initially stretched in length by a factor of two and then resampled by a factor of a half. This will result in an audio signal that has the same length as the original but has a pitch that is twice as high.

In some examples the audio effects can comprise voice effects. This could comprise transforming characteristics of the voice of a singer or speaker or even replacing the singer or speakers voice. The voice effects can be achieved by combining time-scale modification, frequency scale modification, control of formant frequencies and other suitable effected. This could enable voice effects such as creating a cartoon style voice, creating a robotic voice, creating a monstrous voice, changing the gender of the voice or any other suitable voice effects.

At block 207 the method comprises obtaining audio effect information 311. The audio effect information 311 comprises information relating to how application of the one or more audio effects affects one or more signal characteristics of the obtained audio signals 301. The audio effect information can comprise information relating to how application of the one or more audio effects affects one or more signal characteristics of the obtained audio signals 301 as a function of, at least one of, frequency or time.

In some examples the audio effect information 311 can be obtained, at least in part following processing using the audio effect control signal 305. The audio effect control signal 305 can be used to apply the one or more audio effects to the obtained audio signals 301. In such examples the audio effect information 311 can be derived from the information provided within the audio effect control signal 311.

At block 209 the method comprises using the obtained audio effect information 311 and the spatial metadata 303 to enable the indicated spatial rendering of the altered audio signals 309. The spatial rendering enables the altered audio signals 309 to be rendered with similar spatial characteristics as the original obtained audio signals 301. In some examples the spatial rendering can enable the altered audio signals 309 to be rendered with the same spatial characteristics as the original obtained audio signals 301. The spatial metadata 303 and the audio effect information 311 are used to, at least partially, retain spatial characteristics related to the obtained audio signals 301 when the altered audio signals 309 are rendered. This therefore enables reproduction of spatial audio even when one or more audio effects have been applied.

Any suitable processes can be used to enable spatial rendering of the altered audio signals 309. In some examples the spatial rendering can comprise generating modified spatial metadata 315 based on the audio effect information and using the modified spatial metadata 315 to render the altered audio signals 309. In some examples the spatial rendering can comprise adjusting one or more frequency bands used for rendering the altered audio signals 309 and/or adjusting the sizes of one or more time frames used for rendering the altered audio signals 309.

It is to be appreciated that the methods used to implement the examples of the disclosure could comprise additional blocks that are not shown in FIG. 2. For instance, in some examples the method could comprise at least partially, compensating for spatial characteristics from the obtained audio signals 301 before using the audio effect control signal 305 to apply one or more audio effects. The spatial characteristics that are, at least partially, compensated for could comprise frequency dependent characteristics such as binaural characteristics. The audio effect control signal 305 can then be applied to the audio signal from which the spatial characteristics have been, at least partially, compensated for. The spatial characteristics can then be reapplied once the audio effects have been applied.

In some examples the method can comprise analysing covariance matrix characteristics of the altered audio signals 309 and adjusting the spatial rendering so that the covariance matrix of the rendered audio signals match a target covariance matrix. This can ensure that, at least some, of the spatial characteristics of the obtained audio signals 301 are retained in the altered audio signals 309.

FIG. 3 schematically illustrates modules that can be implemented using an example apparatus 101 so as to enable examples of the disclosure.

The modules of the apparatus 101 is configured to obtain one or more audio signals 301. The modules of the apparatus 101 are also configured to obtain the spatial metadata 303 associated with the one or more audio signals 301. The audio signals 301 and the spatial metadata 303 together provide parametric spatial audio signals.

The parametric spatial audio signals can originate from any suitable source. In some examples the parametric spatial audio signals can be obtained from a microphone array and spatial analysis of the microphone signals. The microphone array could be provided in the same device as the apparatus 101 or in a different device. In some examples the parametric spatial audio signals could be obtained from processing of stereo or surround signals such as 5.1 signals.

The modules of the apparatus 101 are also configured to receive one or more audio effect control signals 305. The audio effect control signal 305 is an input that comprises information that enables an audio effect to be applied to the audio signal 301. The audio effect control signal 305 therefore controls the audio effect applied to the one or more obtained audio signals. The audio effect can be any audio effect that alters spectral or temporal characteristics of the audio signal 301. The audio effect could be a change in playback rate, a pitch shift, voice effects or any other suitable audio effects. The audio effect control signal 305 can comprise parameters of the audio effect, pre-set indicators or any other suitable information.

The audio effect control signal 305 can comprise a pitch scaling factor s_{f}, a temporal scaling factor sₜ and any other information that enables the desired audio effect to be applied to the audio signal 301.

The modules of the apparatus 101 are configured so that the audio signal 301 and the audio effect control signal 305 are provided to the audio effect module 307. The audio effect module 307 enables one or more audio effects to be applied to the obtained audio signals 301.

In this example the applying the audio effect comprises processing the audio signal to alter the pitch and the playback rate of the audio signal 301. Any suitable processes can be used to alter the pitch and/or playback rate of the audio signal 301. In examples where the pitch and the playback rate are linearly connected the process could comprise resampling the audio. In some examples the pitch and the playback rate could be independently processed.

Once the audio effect has been applied the audio effect module 307 provides one or more altered audio signals as an output. In this example the altered audio signal is an effect-processed audio signal 309.

The audio effect module 307 also provides audio effect information 311 as an output. The audio effect information 311 provides information that indicates how signal characteristics of the audio signal 301 are affected by the application of the audio effect. In some examples the audio effect information could comprise one or more parameters that are provided within the audio effect control signal 305. For example, the audio effect information 311 could comprise the pitch scaling factor s_{f}, the temporal scaling factor sₜ and any other suitable information.

In some examples the audio effect control signal 305 and the audio effect information 311 can comprise the same information. For example, they can both comprise the same pitch scaling factor s and the same temporal scaling factor sₜ. In such examples the information is used by the audio effect module 307 to apply the audio effect and is also provided as an output of the audio effect module 307.

In other examples the audio effect control signal 305 and the audio effect information 311 can be different. For example, the audio effect control signal 305 could comprise a pre-set index value that enables a set of parameters to be selected. The audio effect information 311 can then comprise the parameters that have been selected.

The modules of the apparatus 101 are configured so that the audio effect information 311 and the spatial metadata 303 are provided to the spatial metadata processing module 313. In this example the spatial metadata processing module 313 is configured to use the audio effect information 311 to modify the spatial metadata 303 so as to retain the spatial characteristics of the parametric spatial audio signal when the effect-processed audio signal 309 is rendered. In some examples the processing of the spatial metadata 303 can comprise spectral and/or temporal remapping of the time and frequency bands of the spatial metadata 303.

As an illustrative example of the spectral and/or temporal remapping of the time and frequency bands of the spatial metadata 303, the spatial metadata 303 can comprise a sound azimuth θ(k,n), sound elevation φ(k,n) and a direct-to-total energy ratio r(k,n), where k is the frequency band index and n is the temporal frame index. To enable remapping the azimuth, elevation, and ratio can be converted to a vector representation v(k,n). In the vector representation the vector direction represents the direction of arrival of sound and the vector length is the ratio as

$$v ( k , n ) = [ \begin{matrix}cos ( θ ( k , n ) ) cos ( φ ( k , n ) ) \\ sin ( θ ( k , n ) ) cos ( φ ( k , n ) ) \\ sin ( φ ( k , n ) )\end{matrix} ] r ( k , n )$$

In this processing it can be assumed that for any index, where v(k,n) is not defined, for example for negative indices of k or n then v(k,n)=[0 0 0]^{T}.

The centre temporal position of the n^{th} metadata frame is denoted as t(n) and the center frequency of the kth metadata band is denoted f(k). The spatial metadata 303 is then mapped to new positions corresponding to the temporal and spectral shifting of the applied audio effect. The new, mapped positions can be denoted as t(n)sₜ and f(k)s_{f}.

The effect processed audio signal 309 is provided at the original sampling rate even if it has been altered in time and frequency and so the modified spatial metadata 315 also needs to be provided at the original temporal and spectral resolution. The spatial metadata 303 at the mapped positions therefore needs to be interpolated to the same resolution. That is, for each position t(n), f(k) of the original audio signal 301 new modified spatial metadata values have to be interpolated based on the mapped positions.

For each (n,k), the following four indices are determined:
Index n₁ which provides the largest negative value to equation t(n₁)sₜ−t(n)
Index n₂ which provides the smallest non-negative value to equation t(n₂)sₜ−t(n)
Index k₁ which provides the largest negative value to equation f(k₁)s_{f}−f(k)
Index k₂ which provides the smallest non-negative value to equation f(k₂) s_{f}−f(k)

It is to be noted that n₁ and n₂ are variables dependent on n, and k₁ and k₂ are variables dependent on k. These dependencies have not been written out above for conciseness.

Then, interpolation weights along time and frequency axes are formulated as follows:

$${w}_{t} ( n ) = \frac{t ( n ) - t ( {n}_{1} ) {s}_{t}}{t ( {n}_{2} ) {s}_{t} - t ( {n}_{1} ) {s}_{t}}$$

$${w}_{f} ( k ) = \frac{f ( k ) - f ( {k}_{1} ) {s}_{f}}{f ( {k}_{2} ) {s}_{f} - f ( {k}_{1} ) {s}_{f}}$$

Then, the interpolated metadata vector is

$$\begin{matrix}{v}^{′} ( k , n ) = v ( {k}_{1} , {n}_{1} ) ( 1 - {w}_{f} ( k ) ) ( 1 - {w}_{t} ( n ) ) \\ + v ( {k}_{2} , {n}_{1} ) {w}_{f} ( k ) ( 1 - {w}_{t} ( n ) ) \\ + v ( {k}_{1} , {n}_{2} ) ( 1 - {w}_{f} ( k ) ) {w}_{t} ( n ) \\ + v ( {k}_{2} , {n}_{2} ) {w}_{f} ( k ) {w}_{t} ( n )\end{matrix}$$

Then, denoting v′(k,n)=[v₁(k,n) v₂(k,n) v₃(k,n)]^{T}, the values of the modified spatial metadata are

$${θ}^{′} ( k , n ) = a tan 2 ( {v}_{2} ( k , n ) , {v}_{1} ( k , n ) )$$

$${φ}^{′} ( k , n ) = a tan 2 ( {v}_{3} ( k , n ) , \sqrt{{v}_{1} ( k , n ) {v}_{1} ( k , n ) + {v}_{2} ( k , n ) {v}_{2} ( k , n )} )$$

$${r}^{′} ( k , n ) = \sqrt{{v}_{1} ( k , n ) {v}_{1} ( k , n ) + {v}_{2} ( k , n ) {v}_{2} ( k , n ) + {v}_{3} ( k , n ) {v}_{3} ( k , n )}$$

It is to be appreciated that other processes for modifying the spatial metadata 303 could be used in other examples of the disclosure.

Once the spatial metadata 303 has been processed the spatial metadata processing module 313 provides the modified spatial metadata 315 as an output.

The modules of the apparatus 101 are configured so that the effect-processed audio signal 309 and the modified spatial metadata 315 are provided to the spatial synthesis module 317. The spatial synthesis module 317 is configured to use modified spatial metadata 315 to enable spatial rendering of the effect-processed audio signals 309. The modified spatial metadata 315 has been mapped to provide updated spatial information synchronised with to the effect-processed audio signal 309. This enables the modified spatial metadata 315 to be used in a manner corresponding to the way the spatial metadata 303 can be used to enable spatial rendering of the audio signal 301 if no audio effects had been applied.

Any suitable process can be used by the spatial synthesis module 317 to enable spatial rendering of the effect-processed audio signal 309.

In examples where the audio signal 301 (and the effect-processed audio signal 309) are stereo signals the processing by the spatial synthesis module 317 can comprise:
1) Transforming the effect-processed audio signal 309 to time-frequency domain. This transform could be done by use of a short-time Fourier transform (STFT) or any other suitable means.
2) In frequency bands, measuring the covariance matrix of the time-frequency audio signals.
3) In frequency bands, determining a target overall energy. The target overall energy is the sum of diagonal elements of the measured covariance matrix.
4) In frequency bands, determining a target covariance matrix based on the target overall energy, the modified spatial metadata 315, and head related transfer function (HRTF) data. The target covariance matrix is composed of a direct part summed with an ambient part. The direct part of the target covariance matrix is based on r′(k,n), the overall energy and the HRTF data for the direction θ′(k,n) and φ′(k,n). The ambient part of the target covariance matrix is based on 1−r′(k,n), overall energy and a diffuse field covariance matrix based on the HRTF data.
5) In frequency bands, determining a mixing matrix, where the mixing matrix is based on the measured and target covariance matrices, and processing the frequency band signal with the determined mixing matrix to generate the processed frequency band signal.
6) Applying the inverse time-frequency transform, such as an inverse STFT to the processed time-frequency signals.

The above process results in a spatial audio signal 319 in a binaural form being provided as an output of the spatial synthesis module 317. Similar types of processes could be used to provide different types of spatial audio signals such as loudspeaker signals, Ambisonic signals or any other suitable type of signals.

The spatial synthesis module 317 provides a spatial audio signal 319 as an output. The spatial audio signal 319 can be provided to a loudspeaker or headphones or any other suitable device for playback. The spatial audio signal 319 can be a binaural signal, surround sound loudspeaker signal, cross talk cancelled loudspeaker signal, Ambisonic signal or any other suitable spatial audio signal. The spatial audio signal 319 has the audio effect applied to it but the spatial characteristics are modified to correspond to the spatial characteristics of the audio signal 301 and the spatial metadata without the audio effect applied.

The modules of the apparatus 101 as shown in FIG. 3 are therefore configured to enable spatial rendering of effect-processed audio signals 309.

In some examples, the audio effect can corrupt the inter-channel level and/or phase differences of the obtained audio signals 301. To resolve any issues this could cause in the apparatus 101 of FIG. 1 the modified spatial metadata 315 enables the corruption of these parameters to be accounted for. In the examples described above the use of the modified spatial metadata 315 and the covariance matrices enables the corrupted channel level and phase differences to be corrected.

It is to be appreciated that modifications can be made to the modules of the apparatus 101 as shown in FIG. 3. For instance, in some examples the spatial metadata processing module 313 could be omitted, or partially omitted. In such examples the spatial metadata processing, or part of the spatial metadata processing, or processing corresponding to the spatial metadata processing could be performed by the spatial synthesis module 317. In such examples the modules of the apparatus 101 would be configured so that the audio effect information 311 is provided to the spatial synthesis module 317. In such examples, if the audio effect information 311 indicates that the playback rate has been altered then the spatial synthesis module 317 is configured to change the audio frame size for the spatial synthesis. For instance, if the playback rate is reduced by half, then the audio frame size for the spatial synthesis would be doubled. Similarly, if the audio effect information 311 indicates that the pitch has been altered then the spatial synthesis module 317 is configured to change the frequency bands used for the spatial synthesis. The frequency band limits can be changed by the same factor that the pitch has changed. This would enable the original, unmodified spatial metadata 303 to be matched with the effect-processed audio signal 309.

In some examples the apparatus 101 could be provided within an encoding device. In such examples the effect-processed audio signal 309 could be encoded for transmission without being spatially rendered by the apparatus 101. In such examples the effect-processed audio signal 309 and the modified spatial metadata 303 could be provided to an audio encoder module instead of the spatial synthesis modules. The audio encoder module can be configured to encode the effect-processed audio signal 309 using any suitable coding method such as AAC (Advanced Audio Coding) or EVS (Enhanced Voice Services) coding, and to encode the modified spatial metadata 315 using any suitable means. The encoded effect-processed audio signal 309 and modified spatial metadata 315 can then be multiplexed to an audio bit stream. The encoded effect-processed audio signal 309 and modified spatial metadata 315 could be multiplexed with a corresponding video stream. The audio bit stream can then be transmitted to another device, such as a playback device. In these examples the spatial metadata 303 is modified by the spatial metadata processing module 313 at the encoding device so that there is no need to transmit the audio effect information 311 to the playback device.

FIG. 4 schematically shows modules of an audio capturing device 401. The modules can be implemented using apparatus 101 as described above. The capturing device 401 can comprise a microphone array which can be configured to capture spatial audio. The capturing device 401 could comprise a mobile phone, a camera device or any other suitable type of capturing device. The capturing device 401 could also comprise a camera or other imaging devices which can be configured to capture video corresponding to the audio captured by the microphone array.

In the example of FIG. 4 the capturing device 401 obtains microphone array signals 403 from the microphone array. The microphone array signals 403 comprise signals representing the spatial audio that has been captured by the microphones within the array.

The capturing device 401 comprises a pre-processing module 405. The microphone array signals 403 are provided as an input to a pre-processing module 405. The pre-processing module 405 is configured to process the microphone array signals 403 to obtain audio signals 301 with an appropriate timbre for listening or for further processing. For example, the microphone array signals 403 may be equalized, gain controlled or noise processed to remove noise such as microphone noise or wind noise. In such examples the pre-processing module 405 may therefore comprise equalizers, automatic gain controllers, limiters or any other suitable techniques for processing the microphone array signals 403.

The pre-processing module 405 provides an audio signal 301 as an output. The audio signal 301 in this example comprises a pre-processed microphone array signal. The audio signal 301 can be provided to an audio effect module 307 as described above in relation to FIG. 3.

The microphone array signals 403 are also provided as an input to a spatial analysis module 407. The spatial analysis module 407 can be configured to process the microphone array signals 403 so as to obtain the spatial metadata 303. The spatial metadata 303 can comprise information such as, for different frequency bands, direction and direct-to-total energy ratios.

In some examples the spatial analysis module 407 can be configured to use an STFT on the microphone array signals 403 to transform the microphone array signals 403 to the STFT domain. In the STFT domain the spatial analysis module 407 is configured to determine delays that maximize correlation between the audio channels. The delays are determined for the different frequency bands. The delay values for the different frequency bands are then converted to direction parameters. The correlation values at that delay are converted to ratio parameters. This provides spatial metadata 303 comprising direction and ratio parameters as an output of the spatial analysis module 407.

In the example shown in FIG. 4 the modules implemented by the apparatus 101 also receive an audio effect control signal 305 as an input. In this example the audio effect control signal can comprise information that indicates the audio effect that is to be applied to the audio signal 301.

As an example, the capturing device 401 could be used to capture slow motion video and corresponding audio. When the capturing device 401 is configured to capture the slow motion video an indicator can be provided indicating the change in the frame rate. For instance, the indicator could indicate that the video is captured at a higher frame rate of eight times the normal frame rate so as to provide video which is eight times slower. This indicator could be provided within the audio effect control signal 305 to enable a corresponding change in playback rate to be applied to the audio signal 301.

In this example the audio effect module 307 receives the audio effect control signal 305 and uses the information provided in the audio effect control signal 305 to alter the playback rate of the audio signal 301. As the slow-motion video is eight times slower the playback rate of the audio signal 301 must also be eight times slower.

The audio effect module 307 can be configured to reduce the playback rate using any suitable process. In this example the audio effect module 307 can resample the audio signals 301 by the indicated factor. The audio effect module 307 can also apply pitch shifting to avoid unwanted lowering of the audio frequency content. In this example the playback rate would change by a factor of ⅛ and the pitch would change by a factor of ½.

The audio effect module 307 can provide audio effect information 311 as an output. The audio effect information 311 can comprise information indicative of the changes in temporal or spectral characteristics of the audio signals 301. In this example the audio effect information 311 comprises the factors by which the playback rate and pitch have been altered. For this example the audio effect information 311 would comprise the pitch scaling factor s_{f}=0.5 and the temporal scaling factor sₜ=0.125.

The audio effect information 311 can be provided to the spatial metadata processing module 313 which can use the audio effect information 311 to modify the spatial metadata 303 as described in relation to FIG. 3. The modified spatial metadata 315 can then be used to enable spatial rendering by the spatial synthesis module 317 as described in relation to FIG. 3.

FIG. 5 shows an example system 501 according to examples of the disclosure. The system 501 could be provided within a user device such as mobile telephone or any other suitable user device. The system 501 comprises an array of microphones 503, a user interface 511 and a capturing device 401. The capturing device 401 implement modules as shown in FIG. 4 and described above.

The microphones 503 can comprise any means that can be configured to capture an audio signal and convert the captured audio signal into an electrical output signal. The microphones 503 can be configured in a spatial array so as to enable spatial audio to be captured. The microphones 503 can comprise digital microphones 503 or any other suitable type of microphones. The microphones 503 can be configured to provide the microphone array signals 403 to the audio capturing device 401 as shown in FIG. 4 and described above.

The system 501 also comprises a user interface 511. The user interface 511 comprises any means that enable the user to control the system 501. The user interface 511 enables a user to input control commands and other information to the system 501. The user interface 511 could comprise a touch screen, a gesture recognition device, voice recognition device or any other suitable means.

The user interface 511 can be configured to enable video to be captured in response to a user input 505. The user interface 511 can be configured to enable different capture modes for the video. For example, the user interface could enable a user to make an input that causes slow motion video to be captured.

If a slow motion video is selected via the user interface 511 then an audio effect control signal 309 is provided from the user interface 511 to the audio capturing device 401. The audio effect control signal 309 can comprise information indicative of the capture speed of the video. This can information can then be used to alter the playback rate of the audio signals 301.

The audio capturing device 401 can process the microphone array signals 403 and the audio effect control signal 309 as described in relation to FIG. 4, or in any other suitable way, so as to provide the spatial audio signal 319 as an output. In the example of FIG. 5 the system 501 is for use with headphones 519 and so the spatial audio signal 319 can be a binaural signal with the applied audio effect. Other types of spatial audio signal 319 can be provided in other examples of the disclosure.

The system 501 of FIG. 5 is configured so that the spatial audio signal 319 is provided to an encoding module 507. The encoding module 507 can be configured to apply any suitable audio encoding processing to reduce the bit rate of the spatial audio signal 319.

The encoding module 507 provides an encoded audio signal 509 as an output. The encoded audio signal 509 is provided to the memory 107 which stores the encoded audio signal 509.

It is to be appreciated that the system 501 would also be capturing video simultaneously to the capture of the microphone array signals 403. The system 501 would also be configured to perform the corresponding processing slow-motion video capture processing and any other video processing and/or encoding that is needed. The encoded audio signal 509 and video can be multiplexed into one media stream that can then be stored in the memory 107.

The storing of the encoded audio signal 509 and any corresponding video completes the capture stage of the system. The playback stage can be performed at any time after the capture stage.

In the playback stage the encoded audio signal 509 is retrieved from the memory 107 and provided to a decoding module 513. The decoding module 513 is configured to perform a decoding procedure corresponding to the encoding procedure applied by the encoding module 507.

The decoding module 513 provides the decoded spatial audio signal 515 as an output. In this example the decoded spatial audio signal 515 is a binaural signal with the applied audio effect. Other types of spatial audio signal can be used in other examples of the disclosure.

The decoded spatial audio signal 515 is provided to an audio output interface 517 where it is converted from a digital signal to an analogue signal. The analogue signal is then provided to the headphones 519 for playback.

FIG. 6 shows modules that can be implemented by an audio decoding device 601. The modules can be implemented by an apparatus 101. The apparatus 101 can be as shown in FIG. 1 and described above. The audio decoding device 601 could be a mobile phone, a communication device or any other suitable type of type of decoding device.

The audio decoding device 601 can comprise any means for receiving a bit stream 603 comprising an encoded audio signal 509. In some examples the bit stream 603 an be retrieved from a memory 107. In some examples the bit stream 603 can be received from a receiver or any other suitable means.

The bit stream 603 comprises the audio signals 301 and the spatial metadata 303 in an encoded form. The bit stream 603 can originate from an audio capture device which can comprise modules as shown in FIG. 4.

The bit stream 603 is provided to a decoding module 605. The decoding module 605 is configured to decode the bit stream 603. The decoding module 605 can also be configured to demultiplex the bit stream 603 into the separate audio signal 301 and spatial metadata 303. The audio signal 301 and spatial metadata 303 are provided to the modules of the apparatus 101 as shown in FIG. 3 and described above.

The output of the audio decoding device 601 is a spatial audio signal 319 which comprises the audio effects. The spatial audio signal 319 can be provided to any suitable rendering means for playback.

FIG. 7 illustrates another example set of modules that can be implemented using an apparatus 101. In the example set of modules of FIG. 7 the input signal comprises a binaural signal 701. The modules of the apparatus 101 are configured so that the binaural signal 701 is provided to a spectral whitening module 703. The spectral whitening module 703 also receives the spatial metadata 303 as an input.

The spectral whitening module 703 is configured to, at least partially, compensate for binaural-related spectral properties of the binaural signal 701. The binaural signal 701 will contain binaural characteristics that generate a perception of sound at certain directions. For example, the binaural signal 701 contains a binaural spectrum, so that a sound at the front has a different spectrum than a sound at the rear. The spectral whitening module 703 is configured to compensate for these characteristics so that they are not passed through to the effect processed audio signal 309 and the resulting spatial audio signal 319. This avoids the resulting spatial audio signal 319 having a double binaural spectrum, one from the input binaural signals 701 and one applied by the spatial synthesis module 317.

In the example of FIG. 7 the spectral whitening module 703 is configured to compensate for binaural-related spectral properties of the binaural signal 701 before the audio effect is applied by the audio effect module 307 as the audio effect processing can alter the spectrum in a complex manner.

Any suitable process can be used to enable compensating for binaural-related spectral properties of the binaural signals 701. In the example of FIG. 7 the process of compensating for binaural-related spectral properties could comprise:
1) Using the spatial metadata 303 to determine, as a function of time and frequency how the input signal spectrum has been affected by the binaural processing. For example, if for a time-frequency interval, the spatial metadata indicates sound arriving from the front, and the direct-to-ambient ratio is 0.5, the binaural spectrum can be estimated as an average of the diffuse field spectrum (or flat spectrum) and a spectrum of the sound arriving at the front, at that frequency.
2) Formulating equalization gains based on the formulated binaural spectrum information and applying these to the binaural signal 701.

The spectral whitening module 703 provides audio signals 301 as an output. As the binaural spectral characteristics have been compensated for these audio signals 301 can comprise stereo audio signals or any other suitable type of audio signals.

The audio signals 301 can be processed using the audio effect control signal 305 as shown in FIG. 3 and described above.

It is to be appreciated that some of the binaural characteristics of the binaural signal 701 can remain in the audio signal 301. These characteristics can be taken into account by the spatial synthesis module 317. For example, if a covariance matrix estimate based rendering process is used by the spatial synthesis module 317, and if the spectrum of the audio signals 301 has been corrected, it can be configured to generate the appropriate binaural properties (phase-differences, level-differences, correlations) to the processed output 319 regardless of if the audio signals 301 contain some binaural properties (apart from overall binaural spectrum) or not. The needed binaural output properties can be based on the spatial metadata 303 or modified spatial metadata 315.

FIG. 8 illustrates another example system 801. The system 801 of FIG. 8 comprises a capturing/encoding device 803 and a decoding/playback device 805. The capturing/encoding device 803 and the decoding/playback device 805 could be mobile phones or any other suitable type of devices.

The capturing/encoding device 803 comprises one or more microphones. The microphones can be provided in a microphone array 503 that can be configured to spatial audio. The microphone array 503 provides microphone array signals 403 as an output. The microphone array signals 403 are provided to a pre-processing module 405 and also a spatial analysis module 407.

The pre-processing module 405 is configured to process the microphone array signals 403 to obtain audio signals 301 with an appropriate timbre for listening or for further processing. For example, the microphone array signals 403 may be equalized, gain controlled or noise processed to remove noise such as microphone noise or wind noise. In such examples the pre-processing module 405 may therefore comprise equalizers, automatic gain controllers, limiters or any other suitable techniques for processing the microphone array signals 403.

The pre-processing module 405 provides an audio signal 301 as an output. The audio signal 301 in this example comprises a pre-processed microphone array signal. The audio signal 301 can be provided to an encoding module 507.

The spatial analysis module 407 can be configured to process the microphone array signals 403 so as to obtain the spatial metadata 303. The spatial metadata 303 can comprise information such as, for different frequency bands, direction and direct-to-total energy ratios. The spatial metadata 303 can also be provided as an input to the encoding module 507.

The encoding module 507 can be configured to apply any suitable audio encoding processing to the audio signal 301 and spatial metadata 303. The encoding module 507 can also be configured to multiplex the audio signal 301 and spatial metadata 303 into a bit stream 807. The bit stream could be a 3^{rd} generation partnership project (3GPP) immersive voice and audio services (IVAS) bit stream, or any other suitable type of bit stream.

The encoding module 507 provides an encoded bit stream 807 as an output. The bit stream 807 can be transmitted to the decoding/playback device 805 via any suitable communications network and interfaces.

It is to be appreciated that the capturing/encoding device 803 can also comprise an image capturing module that can be configured to capture video and perform the appropriate video processing. The video can then be encoded and multiplexed with the audio signal 301 to provide a combined media bit stream 807.

The bit stream 807 can be received by the decoding/playback device 805. In the decoding/playback device 805 the bit stream 807 is provided to an audio decoding device that can comprise the modules as shown in FIG. 6 and described above.

The decoding/playback device 805 also comprises a user interface 511. The user interface 511 comprises any means that enable the user to control the system 501.

The user interface 511 enables a user to input control commands and other information to the system 501. The user interface 511 could comprise a touch screen, a gesture recognition device, voice recognition device or any other suitable means.

In the example of FIG. 8 the user interface 511 enable a user to select a desired playback mode for the audio signal 301. For example the user interface 511 can detect a user input selecting a type of playback mode such as pitch-shifted audio rendering or any other suitable type of rendering with an applied audio effect.

If pitch shifting or other types of audio effect are selected via the user interface 511 then an audio effect control signal 309 is provided from the user interface 511 to the audio decoding device 601. The audio effect control signal 309 comprises information indicative of the audio effect selected via the user interface 511.

The audio decoding device 601 then uses the audio effect control signal 309 to process the bit stream 801 as shown in FIG. 6 and described above. The audio decoding device 601 provides a spatial audio signal 515 as an output. The spatial audio signal 515 is provided to the audio output interface 517 where it is converted from a digital signal to an analogue signal. The analogue signal is then provided to the headphones 519 for playback.

It is to be appreciated that in some examples of the disclosure the bit stream 807 can also comprise other data such as video. In such examples the decoding/playback device 805 is configured to decode the encoded video stream and enable the video to be reproduced by a display or other suitable means.

It is also to be appreciated that both the capturing/encoding device 803 and the decoding/playback device 805 can comprise memory 107 that can be configured to store the bit stream 807 as needed.

It is to be appreciated that variations can be made to examples described above. For instance, some of methods blocks and modules described above can be combined or separated into a different set of processing blocks. For instance, in some examples the audio effect module 307 can be combined with the spatial synthesis module 317. If the audio effect processing takes place in the STFT (or other time-frequency) domain, then it could be more practical for the audio effect processing to be performed after the STFT by the spatial synthesis module 317.

In some examples the spatial metadata processing module 313 can also perform additional modification of the spatial metadata 303. For instance, if the audio effect comprises voice changing functions then in addition to the spectral and temporal mappings described above the spatial metadata processing module 313 can be configured to alter the spatial parameters at some frequencies of the spatial metadata 303. If there is background ambience in the audio signals 301 then the ratio between the voice and the background components can be changed at these frequencies. Correspondingly, it may be, that some parameters such as a direct-to-total energy ratios need to be updated to account for such changes.

It is to be appreciated that in some examples the audio effect information 311 can be provided to the spatial synthesis module 317. In such examples the spatial synthesis module 317 can be configured to adapt the processing based on the audio effect information 311. For example, if the audio effect causes pitch-shifting of the audio signal 301 then the spatial synthesis module 317 can be configured to change the frequency band limits accordingly.

As an illustrative example, if a set of metadata comprising direction and ratio is determined for a frequency interval of 400-800 Hz, then if the pitch is shifted upwards by a factor of two, then the same, non-modified, set of spatial metadata can be used by the spatial synthesis module 317 for a frequency interval ranging between 800 Hz-1600 Hz.

Similarly, any changes of playback rate can be taken into account by changing the frame size used by the spatial synthesis module 317. For example, if the playback rate is increased by a factor of two, then the frame size could be reduced to half at the spatial synthesis module 317.

In some examples a combination of both spatial metadata mapping and adapting the processing used by the spatial synthesis module 317 could be used.

In some examples the pitch and/or the playback rate of the audio signal 301 can vary as a function of time and/or frequency rather than being changed by a fixed factor. In some examples, the mapping of the audio (and the metadata) in time and in frequency may be arbitrary. In such cases, the following process for mapping the spatial metadata 303 can be used:
1) Determine how the spatial metadata 303 maps into new spectral and temporal positions
2) When determining the modified spatial metadata 315, the values of the modified spatial metadata 315 are generated based on the nearby mapped metadata positions. As a simple example, the nearest mapped metadata position can be selected. As a more complex example, three mapped metadata positions which form a triangle, in the time-frequency plane where the updated metadata position resides, can be selected and based on these three metadata values the update metadata value is interpolated.

In some examples, the ratio can be interpolated using

$$\begin{matrix}{r}^{′} ( k , n ) = r ( {k}_{1} , {n}_{1} ) ( 1 - {w}_{f} ( k ) ) ( 1 - {w}_{t} ( n ) ) \\ + r ( {k}_{2} , {n}_{1} ) {w}_{f} ( k ) ( 1 - {w}_{t} ( n ) ) \\ + r ( {k}_{1} , {n}_{2} ) ( 1 - {w}_{f} ( k ) ) {w}_{t} ( n ) \\ + r ( {k}_{2} , {n}_{2} ) {w}_{f} ( k ) {w}_{t} ( n )\end{matrix}$$

The ratio interpolation can apply a combination of the methods described above. For example, if the first method provides a value below a threshold, for example, below 0.25, then the result of the first method is selected, otherwise the result of the second method is selected. The threshold can be smoothed, so that when the first ratio is 0.25 or below then first ratio is selected; and when the first ratio is above 0.5 then the second ratio is selected; and when the first ratio is between 0.25 and 0.5, then interpolation occurs between the first and the second ratio, to obtain the ratio value of the modified spatial metadata 315. This selection between the different ratio interpolation methods mean that when the direction parameters of the data points contributing to the interpolation indicate very different directions, then the ratio value is set small because the direction is not well determined and is thus unreliable. When the direction parameters point generally to similar directions, then the ratio value is more appropriately estimated for the modified spatial metadata.

It is to be appreciated that these described methods for interpolating the ratio and other parameters of the modified spatial metadata 315 are examples and that other methods could be used in other examples of the disclosure.

It is to be appreciated that any suitable methods for rendering at spatial synthesis 317 the effect processed audio signals 309 and spatial metadata 303, or modified spatial metadata 315 to a spatial audio signal 319 can be used. For loudspeaker rendering an example method comprises:
1) Transform the effect processed audio signals 309 to time-frequency domain, for example, by use of a short-time Fourier transform (STFT)
2) In frequency bands, dividing the effect processed audio signals 309 into direct and ambient parts by multiplication with gains \sqrt{r′(k,n)} and \sqrt{1−r′(k,n)}
3) In frequency bands, amplitude-panning the direct part to the direction determined by θ′(k,n) and φ′(k,n), according to an amplitude panning law matched to the loudspeaker configuration
4) In frequency bands, decorrelating the ambient part to all loudspeaker output channels
5) Applying the inverse time-frequency transform (e.g., inverse STFT) to the processed time-frequency signals (the processed loudspeaker channels that combine the direct and ambient processed parts)

The term “comprise” is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one non-transitory memory storing instructions that, when executed with the at least one processor, cause the apparatus to:
obtain one or more audio signals;
obtain one or more spatial metadata relating to the one or more obtained audio signals wherein the one or more spatial metadata comprises information that indicates how to spatially reproduce the one or more obtained audio signals;
apply one or more audio effects to the one or more obtained audio signals to provide one or more altered audio signals;
obtain audio effect information where the audio effect information comprises information relating to how application of the one or more audio effects affects one or more signal characteristics of the one or more obtained audio signals; and
use the obtained audio effect information and the one or more spatial metadata to enable the indicated spatial rendering of the one or more altered audio signals.

2. An apparatus as claimed in claim 1, wherein the audio effect comprises an effect that alters at least one of:
spectral characteristics of the one or more obtained audio signals; or
temporal characteristics of the one or more obtained audio signals.

3. An apparatus as claimed in claim 1, wherein the audio effect information comprises information relating to how application of the one or more audio effects affects one or more signal characteristics of the one or more obtained audio signals as a function of at least one of: frequency; or time.

4. An apparatus as claimed in claim 1, wherein the audio effect information is obtained, at least in part, from processing using an audio effect control signal, wherein the audio effect control signal controls the audio effect applied to the one or more obtained audio signals.

5. An apparatus as claimed in claim 1, wherein the obtained audio effect information and the one or more spatial metadata are used to enable the indicated spatial rendering of the one or more altered audio signals comprises generating modified spatial metadata based on the audio effect information and the modified one or more spatial metadata to render the altered audio signals.

6. An apparatus as claimed in claim 1, wherein the obtained audio effect information and the one or more spatial metadata are used to enable the indicated spatial rendering of the one or more altered audio signals comprises adjusting one or more frequency bands used for rendering the one or more altered audio signals.

7. An apparatus as claimed in claim 1, wherein the obtained audio effect information and the one or more spatial metadata are used to enable the indicated spatial rendering of the one or more altered audio signals comprises adjusting the sizes of one or more time frames used for rendering the altered audio signals.

8. An apparatus as claimed in claim 1, wherein the one or more altered audio signals comprise an effect-processed audio signal.

9. An apparatus as claimed in claim 1, where the memory storing the instructions, when executed with the at least one processor, cause the apparatus to, at least partially, compensate for spatial characteristics from the one or more obtained audio signals before applying one or more audio effects.

10. An apparatus as claimed in claim 9, wherein the spatial characteristics, that are at least partially compensated for, comprise binaural characteristics.

11. An apparatus as claimed in claim 1, where the memory storing the instructions, when executed with the at least one processor, cause the apparatus to analyse covariance matrix characteristics of the one or more altered audio signals and adjust the spatial rendering so that the covariance matrix of the rendered audio signals match a target covariance matrix.

12. An apparatus as claimed in claim 1, wherein the spatial metadata and the audio effect information are used to, at least partially, retain the spatial characteristics of the one or more obtained audio signals when the one or more altered audio signals are rendered.

13. (canceled)

14. An apparatus as claimed in claim 1, wherein the one or more obtained audio signals are captured with the apparatus.

15. An apparatus as claimed in claim 1, wherein the one or more obtained audio signals are captured with a separate capturing device and transmitted to the apparatus.

16. An apparatus as claimed in claim 15, wherein at least one of the one or more spatial metadata, or an audio effect control signal is transmitted to the apparatus from the capturing device.

17. A method comprising:
obtaining one or more audio signals;
obtaining one or more spatial metadata relating to the one or more obtained audio signals wherein the one or more spatial metadata comprises information that indicates how to spatially reproduce the one or more obtained audio signals;
applying one or more audio effects to the one or more obtained audio signals to provide one or more altered audio signals;
obtaining audio effect information where the audio effect information comprises information relating to how application of the one or more audio effects affects one or more signal characteristics of the one or more obtained audio signals; and
using the obtained audio effect information and the one or more spatial metadata to enable the indicated spatial rendering of the one or more altered audio signals.

18. A method as claimed in claim 17, wherein the audio effect comprises an effect that alters at least one of:
spectral characteristics of the one or more obtained audio signals; or
temporal characteristics of the one or more obtained audio signals.

19. A non-transitory computer readable medium including a computer program comprising computer program instructions that, when executed with processing circuitry, cause:
obtaining one or more audio signals;
obtaining one or more spatial metadata relating to the one or more obtained audio signals wherein the one or more spatial metadata comprises information that indicates how to spatially reproduce the one or more obtained audio signals;
applying one or more audio effects to the one or more obtained audio signals to provide one or more altered audio signals;
obtaining audio effect information where the audio effect information comprises information relating to how application of the one or more audio effects affects one or more signal characteristics of the one or more obtained audio signals; and
using the obtained audio effect information and the one or more spatial metadata to enable the indicated spatial rendering of the one or more altered audio signals.

20. A non-transitory computer readable medium including the computer program as claimed in claim 19, wherein the audio effect comprises an effect that alters at least one of:
spectral characteristics of the one or more obtained audio signals; or
temporal characteristics of the one or more obtained audio signals.

21-22. (canceled)

23. An Apparatus as claimed in claim 1, wherein the one or more spatial metadata comprises, for one or more frequency sub-bands:
a sound direction parameter, and
an energy ratio parameter.
